(19) United States
(12) Patent Application Publication
(10) Pub. No.: US 2014/0151348 A1
(43) Pub. Date: Jun. 5, 2014

(54) METHOD FOR GENERATING AT LEAST ONE THROUGH-HOLE AND DEVICE FOR CARRYING OUT SUCH A METHOD

(71) Applicants: Thorsten Bauer, Memmelsdorf (DE); Jens Koenig, Markgroeningen (DE)

(72) Inventors: Thorsten Bauer, Memmelsdorf (DE); Jens Koenig, Markgroeningen (DE)

(73) Assignee: ROBERT BOSCH GMBH, Stuttgart (DE)

(21) Appl. No.: 14/131,137

(22) PCT Filed: Jun. 18, 2012
(86) PCT No.: PCT/EP2012/061588

§ 371 Date: Jan. 6, 2014

(30) Foreign Application Priority Data
Jul. 5, 2011 (DE) 10 2011 078 651.1

(51) Int. Cl. B23K 26/38; B23K 26/18

(52) U.S. Cl. CPC B23K 26/388; B23K 26/18
USPC 219/121.71; 219/121.7

(57) ABSTRACT

The invention relates to a method for generating at least one through-hole (3, 4) in a wall of a workpiece (2) bounding a hollow space (12) of the workpiece (2), said method using a laser beam (7) directed onto the wall (9) from the exterior. A paste-like protective agent (13) is thereby introduced into the hollow space of the workpiece (2). The paste-like protective agent (13) is applied in an extension (10) of the laser beam (7) guided through the through-hole (3) in front of a rear wall bounding the hollow space (12). Reliable protection of the rear wall (11) during laser drilling of the through-hole (3) is thereby ensured.

### BACKGROUND OF THE INVENTION

The invention relates to a method for generating a through-hole in a wall of a workpiece and a device for carrying out such a method. The invention particularly relates to the field of manufacturing of nozzle bores, in particular for fuel injection valves.

The WIPO patent application WO 2004/087364 discloses a method for producing a through-hole in a workpiece comprising a hollow space by means of a laser. The problem underlying this known method is that after penetrating the wall of the workpiece, the laser beam enters into the hollow space and strikes the opposite wall. In so doing, the laser damages the wall opposite the bored hole after penetrating the wall. Thus, a protective element is disposed in the hollow space in the known method such that after the laser beam generated by the laser penetrates the wall of the workpiece, the laser beam strikes the protective element; and a specific minimum distance separates the inner wall of the workpiece from the protective element. The minimum distance is thereby greater than or equal to 0.1 mm. In order to prevent the laser beam from striking the wall opposite the injection orifice, a protective element in the form of a sphere can, for example, be loosely inserted into the blind hole. When the laser beam breaks through the wall of the nozzle, said beam then strikes the sphere which is disposed in the hollow space between the wall comprising the through-hole and the opposite wall. As a result, a recess is formed in the sphere. The distance between the sphere and the inner wall of the hollow space prevents material, which is removed from the sphere as a result of the laser beam striking the same, from being sprayed back directly into the through-hole and lodging there.

The method disclosed by the WIPO patent application WO 2004/087364 has the disadvantage that the protective element, which is designed, for example, as a sphere, is gradually penetrated ever deeper by the laser beam. Firstly, the protective element is thereby increasingly damaged so that said element has to be regularly replaced. As the case may be, portions of the protective element can come loose when said element is struck by the laser beam so that pieces of the protective body are separated and remain as undesirable waste in the hollow space of the workpiece to be processed. A reliable removal of such waste must therefore be taken into account during manufacture. The problem furthermore exists that material from the protective element is sprayed back to an undesirable position in the proximity of the through-hole during laser penetration, in particular to a valve seat surface or according to the statistics is even deposited at or in the through-hole despite the distance separating the inner wall of the workpiece from the protective element. A certain number of defective products thus result which can only be reliably detected by means of individual tests.

### SUMMARY OF THE INVENTION

The method according to the invention and the device according to the invention have in contrast the advantage that the production of a through-hole in a wall of a workpiece is improved. In particular, it is possible to carry out the method with consistently high quality and uninterrupted pulsing for a plurality of processes. In addition, the quality in carrying out the method can be improved.

It is advantageous that the hollow space of the workpiece is filled with the paste-like protective agent at least along the extension of the laser beam guided through the through-hole. It is further advantageous that the paste-like protective agent is replenished in the hollow space when laser drilling the through-hole by means of the laser beam. In contrast to a liquid protective agent, the paste-like protective agent does not drain off across a laser drilled through-hole. This allows for the configuration of a plurality of through-holes on the workpiece. Protective agent which possibly escapes across the previously drilled through-holes can be relatively easily replenished due to the small amount that escapes per time unit. In addition, protective agent which was possibly heated by the laser beam can possibly vaporize, wherein vapor bubbles can form. The vaporized protective agent can then likewise be replaced, wherein gas and/or vapor bubbles can then be closed again by pressure. It is thereby also advantageous that the paste-like protective agent is fed into the hollow space of the workpiece with a feed pressure that is sufficiently large to in turn press shut the gas and or vapor bubbles produced in the paste-like protective agent by the laser.

It is further advantageous that the paste-like protective agent comprises metal particles. In so doing, a scattering of the laser beam can be selectively influenced. In addition, it is advantageous that the paste-like protective agent comprises pieces of fiberglass. This likewise allows the scattering properties of the laser beam to be influenced. In particular, a length and a diameter of the fiberglass pieces can be matched to the wave length of the laser.

It is furthermore advantageous that the paste-like protective agent is formed on the basis of a ceramic powder in aqueous solution or in a non-aqueous dispersion in which the metallic particles or the pieces of fiberglass are deposited. As a result, a particle size distribution of the ceramic powder can be adjusted with regard to the wave length of the laser in an advantageous manner. The particle size or a region of the particle size distribution can thereby lie within the order of magnitude of the wave length of the laser in order to improve the scattering properties. If need be, the ceramic powder can at least be partially predetermined even with a particle size distribution that is in the range of being ten to twenty times greater than the wave length of the laser. As a result, the scattering properties can be selectively influenced on the one hand; and the viscosity of the paste-like protective agent can be selectively influenced on the other hand.

It is furthermore advantageous that a conveying device, which conveys the paste-like protective agent, is partially inserted into the hollow space of the workpiece, that a working portion of the hollow space is bounded by the conveying device and that the working portion of the hollow space is filled with the paste-like protective agent by the conveying device. A refilling of the protective agent that has already been used up is thereby advantageous during the processing process. An optimal use of the protective agent can therefore take place with low consumption of said agent.

After the through-hole or a plurality of through-holes has been drilled, the paste-like protective agent remaining in the hollow space can be flushed out.

### BRIEF DESCRIPTION OF THE DRAWINGS

Preferred exemplary embodiments of the invention are explained in detail in the following description with reference to the attached drawing. In the drawing:

FIG. 1 shows a workpiece and a device for carrying out a method for generating at least one through-hole in a wall of the workpiece in a partial schematic sectional view according to an exemplary embodiment of the invention.

### DETAILED DESCRIPTION

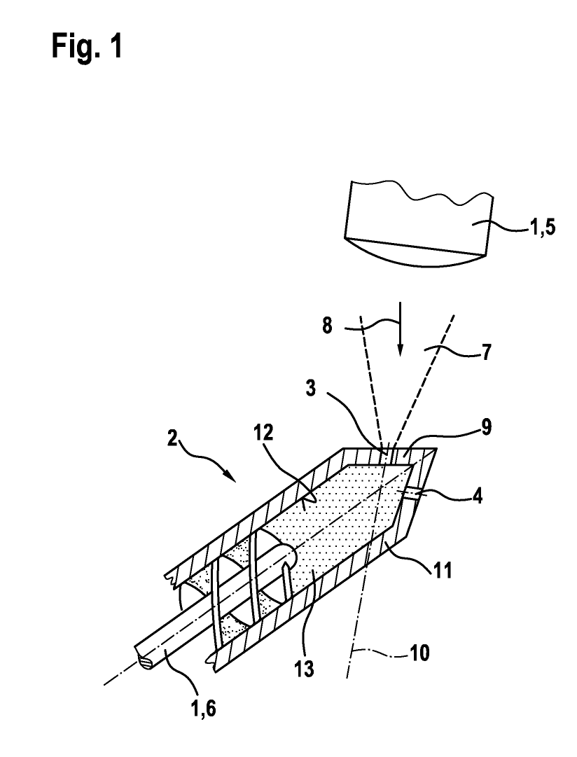

FIG. 1 shows a device 1 and a workpiece 2 in a partial schematic sectional view pursuant to an exemplary embodiment of the invention. The device 1 serves thereby to carry out a method for generating through-holes in the workpiece 2. The method is particularly suited to configuring through-holes which serve as nozzle holes for nozzle bodies of a fuel injection valve. The device 1 is particularly suited to carrying out such a method. The device 1 according to the invention and the method according to the invention are, however, also suited to other applications.

The workpiece 2 can, for example, be embodied as a nozzle body 2. In so doing, through-holes 3, 4 are exemplarily depicted in the workpiece 2.

The device 1 comprises a laser device 5 which is schematically depicted and a conveying device 6 which is schematically depicted. The conveying device 6 is thereby exemplarily depicted as a screw-conveyor but is not limited to this embodiment.

The laser device 5 generates a laser beam 7 which is radiated onto the workpiece 2 in a direction 8. In so doing, the laser beam 7 can be focused on a wall 9 of the workpiece 2 at the location of the through-hole 3 or, respectively, the through-hole to be generated. An extension 10 of the laser beam 7 guided through the through-hole 3 results in the direction 8. The extension 10 of the laser beam 7 strikes a rear wall 11 of the workpiece 2. In this regard, the term rear wall 11 arises with respect to the wall 9 and the direction 8 of the laser beam. The laser beam 7 is thereby intended to generate a through-hole 3 in the wall 9 while the rear wall 11 is to remain intact.

A hollow space 12 of the workpiece 2 is situated between the wall 9 and the rear wall 11. The through-holes 3, 4 which are generated open into the hollow space 12; thus enabling fuel, for example, to be sprayed via said through holes 3, 4 into a combustion chamber of an internal combustion engine or the like if the workpiece 2 is to be used as a nozzle body of a fuel injection valve.

The conveying device 6 conveys a paste-like protective agent 13 into the hollow space 12. In this case, the paste-like protective agent 13 is based on a ceramic powder in an aqueous solution. A particle size distribution of the ceramic powder is thereby matched to the wave length of the laser beam 7. For example, at least a portion of the ceramic powder can have a particle size distribution in the order of magnitude of the wavelength of the laser beam 7 in order to achieve a large scattering. Another portion of the ceramic powder can also have a particle size distribution in the order of magnitude of ten to twenty times the wave length of the laser beam 7. As a result, the consistency of the paste-like protective agent 13 can be favorably influenced.

The paste-like protective agent 13 ensures on the one hand a protection of the rear wall 11 because the radiated laser beam 7 does not penetrate through the paste-like protective agent to said rear wall 11. In addition, the protective agent 13 remains at least for the most part within the hollow space 12 due to the consistency thereof and escapes only to a small degree from the hollow space 12 via, for example, the through-hole 4. As a result, the method is also suited to generating a plurality of through-holes 3, 4 in a single workpiece 2. That would, for example, not be possible with a liquid, in particular water, because water would escape to a high degree via the through-hole 4. Moreover, vapor bubbles develop in great number in water. In the event that gas and/or vapor bubbles form in the paste-like protective agent 13, said bubbles can be pressed shut again by means of the conveying pressure of the paste-like protective agent conveyed into the hollow space 12 of the workpiece 2. A reliable protection of the rear wall 11 is thus ensured. In addition, it is ensured that the method can be carried out in an economical manner. In order to further improve the protective effect of the protective agent 13, for example with respect to high energy densities of the laser beam 7, further constituents can be added to the paste-like protective agent 13. For example, said paste-like protective agent 13 can comprise metallic particles. Additionally or alternatively, said paste-like protective agent 13 can also comprise pieces of fiberglass. The length and the diameter of such pieces of fiberglass can thereby be matched to the wave length of the laser beam 7.

Solid state lasers having a wave length between 266 nm and 1.5 μm can also be used to drill the through-holes 3,4 by means of the laser device 5. As a result, through-holes 3, 4 which are embodied as micro-holes 3, 4 and have diameters in the range of 0.05 mm up to approximately 0.3 mm can be specially bored. Hence, the advantages of improved beam quality can be utilized for the drilling. In addition, the laser device 5 can generate very short, intensive laser pulses, which facilitate an advantageous processing of the workpiece 2. The protection of the rear wall 11 can thereby be reliably ensured by means of the paste-like protective agent.

The paste-like protective agent 13 can, for example, be pressed into the hollow space 12 of the workpiece 2 with a type of calendar, possibly with the use of an injection lance. By means of the possible highly viscous consistency, which can be achieved by embedding metallic particles, the absorption can be raised to a level which lies above that of a liquid, in particular water. The evaporation of the paste-like protective agent 13 can thus be compensated by a continuous repressing. A loss can likewise be compensated which occurs when said protective agent escapes across through-holes 4 that have already been bored or the like.

The absorption cross section which is available can be adapted to the laser beam 7 generated by embedding metallic particles, pieces of fiber glass or the like. A protection of the rear wall 11 can therefore be ensured at small distances to said rear wall 11.

After the through-holes 3, 4 have been configured in the workpiece 2, the remaining paste-like protective agent 13 can be removed by washing or air-cleaning.

The invention is not limited to the exemplary embodiments described.

1. (canceled)

2. The method according to claim 8, characterized in that the hollow space (12) of the workpiece (2) is filled with the paste-like protective agent (13) at least along the extension (10) of the laser beam (7) guided through the through-hole (3).

3. The method according to claim 8, characterized in that the paste-like protective agent (13) is replenished in the hollow space (12) at least during laser drilling of the through-hole (3) resulting by means of the laser beam (7).

4. The method according to claim 3, characterized in that a plurality of through-holes (3, 4) is generated by means of the laser beam (7) in at least one of the first wall (9) and a further wall (9) of the workpiece (2) in a laser drilling operation.

5. The method according to claim 3, characterized in that the paste-like protective agent (13) is conveyed with a feed pressure into the hollow space (12) of the workpiece (2), which pressure in turn presses shut gas or vapor bubbles which were generated by the laser beam (7) in the paste-like protective agent (13).

6. A device (1) for carrying out a method having the features according to claim 8, wherein a conveying device (6) is provided which serves to convey the paste-like protective agent (13) into the hollow space (12) of the workpiece (2) and wherein the conveying device is embodied as a screw-conveyor or calender.

7. The device according to claim 6, characterized in that the conveying device (6) which conveys the paste-like protective agent (13) is partially inserted into the hollow space (12), in that a working portion of the hollow space (12) is bounded by the conveying device (6) and in that the working portion of the hollow space (12) is filled with the paste-like protective agent (13) by the conveying device (6).

8. A method for generating at least one through-hole (3) in a first wall (9) of a workpiece (2) bounding a hollow space (12) of the workpiece (2), the workpiece having a rear wall (11) bounding the hollow space (12), and the workpiece having an exterior, said method comprising: using a laser beam (7) directed onto the first wall (9) from the exterior; and introducing a paste-like protective agent (13) into the hollow space (12) of the workpiece (2), the paste-like protective agent (13) being applied in the hollow space (12) at least partially in an extension (10) of the laser beam (7) guided through the through-hole (3) in front of the rear wall (11) of the workpiece (2), wherein the paste-like protective agent (13) is formed on the basis of a ceramic powder in an aqueous solution or in a non-aqueous dispersion, in which powder metallic particles or, respectively, pieces of fiberglass are embedded.

9. The method according to claim 8 wherein the paste-like protective agent (13) is formed on the basis of a ceramic powder in an aqueous solution.

10. The method according to claim 8 wherein the paste-like protective agent (13) is formed on the basis of a ceramic powder in a non-aqueous dispersion.

11. The method according to claim 8 wherein the paste-like protective agent (13) is a ceramic powder in which powder metallic particles are embedded.

12. The method according to claim 8 wherein the paste-like protective agent (13) is a ceramic powder in which pieces of fiberglass are embedded.

13. The method according to claim 2, characterized in that the paste-like protective agent (13) is replenished in the hollow space (12) at least during laser drilling of the through-hole (3) resulting by means of the laser beam (7).

14. The method according to claim 13, characterized in that a plurality of through-holes (3, 4) is generated by means of the laser beam (7) in at least one of the first wall (9) and a further wall (9) of the workpiece (2) in a laser drilling operation.

15. The method according to claim 14, characterized in that the paste-like protective agent (13) is conveyed with a feed pressure into the hollow space (12) of the workpiece (2), which pressure in turn presses shut gas or vapor bubbles which were generated by the laser beam (7) in the paste-like protective agent (13).
